(19) United States
(12) Patent Application Publication
(10) Pub. No.: US 2007/0144951 A1
(43) Pub. Date: Jun. 28, 2007

(54) Apparatus for dissolving filth treatment bags formed by water soluble film

(76) Inventors: Masachika Kono, Uji-shi (JP); Kenta Matsuoka, Fushimi-ku (JP); Takayuki Matsuoka, Fushimi-ku (JP)

Correspondence Address: MURAMATSU & ASSOCIATES, Suite 310, 114 Pacifica, Irvine, CA, 92618, US

(21) Appl. No.: 11/605,518

(22) Filed: Nov. 28, 2006

(30) Foreign Application Priority Data
Dec. 26, 2005 (JP) 2005-381390

(51) Int. Cl. B01D 21/24; A47K 11/02

(52) U.S. Cl. 210/97; 4/449; 4/111.1; 210/86; 210/198.1

(57) ABSTRACT

An apparatus for dissolving filth treatment bags formed by hot water soluble films in a dissolving tub is disclosed. The apparatus includes a pipe for inputting hot water for dissolving the filth bag storing filth by stirring action of the hot water therefrom, a pipe for outputting vapor including odor generated by a mixture of the filth and the hot water in the dissolving tub, the vapor being generated on a shifting process from a state where the film is divided and collapsed to a stage where the film is dissolved, and a mechanism for cooling the heated wastewater including the dissolved filth bag and the hot water in the dissolving tub and outputting the wastewater into a sewer pipe from the dissolving tub.

This application claims the benefit of foreign filing priority based on Japanese Patent Application No. JP 2005-381390 filed on Dec. 26, 2006, which is incorporated hereinto by reference.

### FILED OF THE INVENTION

This invention is related to an apparatus for dissolving a filth treatment bag formed by a hot water soluble film, and more particularly, to an apparatus including a pipe for completely dissolving the filth treatment bag storing filth by the stirring action of boiled-hot water stream and draining the vapor including odor generated by mixture of the filth with the hot water on the process where the hot water soluble film is broken and dissolved, and a mechanism for lowering the temperature of the hot wastewater and draining the wastewater to a sewer pipe.

### BACKGROUND OF THE INVENTION

A portable toilet is one of the necessary items for an aged person who needs nursing service or a person who is unable to go to toilet by himself or herself due to illness, etc. The conventional method for disposing filth conducted in hospitals and nursing facilities is to take out a filth container of the portable toilet, to move it to a filth treatment room, to flush the filth stored in the filth container into a filth sink, to clean the filth container by water and a detergent, to come back to a sickroom and to install the filth container back to the portable toilet.

There is another method, which is a method for installing a bag inside the filth container instead of directly evacuating bowels or discharging urine into the filth container, taking out the vinyl bag storing the filth from the container, disposing the filth into a bedpan and disposing the vinyl bag as waste.

There is an apparatus called a bedpan-washer produced by various manufactures as a filth container washing apparatus, which has been widely utilized in hospitals and nursing facilities.

The main purposes of this bedpan-washer are to wash various bedpans and to sterilize bacteria. The method for using the bedpan-washer is to input a filth container and a urine collection cup of the portable toilet in the bedpan-washer, to automatically wash various cups, to jet hot water or steam against the cups and to sterilize the bacteria by irradiating ultraviolet rays onto the cups.

The conventional method for treating filth of a portable toilet, which is widely conducted in hospitals and nursing facilities is to discharge urine, to evacuate bowels and to flush them into a filth sink provided in a filth treatment room. According to this method, since the filth or odor of the filth is adhered in the filth container even after disposing the filth, the filth container has to be clean up by using a detergent every time when flushing the filth in order to keep clean the filth container.

According to the method for installing a bag inside the filth container, tacking out the filth container storing the filth, disposing the filth into a bedpan and disposing the vinyl bag as waste, there are problems that the odor is generated when disposing the vinyl bag and a sanitary problem is associated with the handling of the vinyl bag.

In order to avoid the cleaning work associated with the filth container, there is a bedpan-washer as an automatic cleaning and sterilizing apparatus. However, the bedpan-washer, in general, can process only one container at a time. Thus, there is a problem that the size of the apparatus becomes large when applying this type of bedpan-washer to cleaning work to clean a large number of filth containers of portable toilets at a time.

As described above, there are problems, such as troublesome, odor and sanitary issues associated with a filth treatment method of the portable toilet. Further, there is a problem of processing capability associated with the bedpan-washer.

The common problem of these issues described above is that a plurality of filth treatments cannot be conducted within a short period of time.

The number of times of filth treatment of portable toilets in a relatively large hospital or nursing facilities in a day reaches from several tens to several hundreds. According to the conventional methods described above, the amount of time consumed for the labor of nursing stuffs associated with these work is large.

### SUMMARY OF THE INVENTION

It is therefore, an object of this invention is to provide an apparatus for dissolving a filth treatment bag formed by a hot water soluble film to simply conduct a filth treatment of a portable toilet, to keep the portable toilet clean, to conduct cleaning of larger number of containers within a short time period and to dramatically reduce the time and labor spent for the filth treatment process of the care-stuffs after the usage of the portable toilet.

One aspect of the present invention is an apparatus for dissolving a filth treatment bag formed by a hot water soluble film in a dissolving tub. The apparatus includes a pipe for inputting hot water for dissolving the filth bag storing filth by stirring action of the hot water therefrom, a pipe for outputting vapor including odor generated by a mixture of the filth and the hot water in the dissolving tub, the vapor being generated on a shifting process from a state where the film is divided and collapsed to a stage where the film is dissolved, and a mechanism for cooling heated wastewater including the dissolved filth bag and the hot water in the dissolving tub and outputting the wastewater into a sewer pipe from the dissolving tub.

The apparatus for dissolving a filth treatment bag further includes a lid for covering an opening provided on the dissolving tub, the opening being used for inputting the filth treatment bag into the dissolving tub, a hot water inlet for inputting the hot water into the dissolving tub, the hot water inlet being provided on a sidewall of an upper portion of the dissolving tub, a cooling water inlet for inputting cooling water into the dissolving tub to output wastewater in the dissolving tub by applying a siphon phenomenon, a cleaning water inlet for inputting cleaning water into the dissolving tub after outputting the wastewater from the dissolving tub, a vapor outlet for outputting the vapor, and an underwater heater for raising temperature of the wastewater.

The apparatus for dissolving a filth treatment bag further includes a tank for storing the cooling water, and an apparatus for supplying the hot water.

The apparatus for dissolving a filth treatment bag further includes a sensor for detecting a quantity of the hot water, a sensor for detecting a quantity of the water into the dissolving tub for cooling and outputting hot water from the dissolving tub, and a sensor for detecting a quantity of cleaning water, a computer for controlling an operation of the apparatus for dissolving a filth treatment, wherein the computer controls a series of works of inputting hot water into the dissolving tub, heating the hot water in the dissolving tub, stopping heating operation of the hot water, inputting water into the dissolving tub for cooling, outputting the hot water from the dissolving tub and cleaning an inside of the dissolving tub by using the sensor for detecting a quantity of the hot water, the sensor for detecting a quantity of the water into the dissolving tub for cooling and outputting hot water from the dissolving tub, and the sensor for detecting a quantity of cleaning water after inputting the filth treatment bag formed by hot water soluble film storing filth in the dissolving tub.

According to the present invention, it becomes unnecessary to clean a filth container. Further, it also releases nursing stuffs from the problems of odor and unsanitary associated with the treatment of a vinyl bag. Thus, the time spent for the treatment can be minimized, which creates an extra time to be utilized for nursing and caring patients.

### BRIEF DESCRIPTION OF THE DRAWINGS

FIG. 1 illustrates a front view of a dissolving apparatus of the present invention for dissolving a filth treatment bag formed by a hot water soluble film.

FIG. 2 illustrates a side view of the dissolving apparatus of the present invention for dissolving the filth treatment bag formed by the hot water soluble film.

FIG. 3 illustrates an example of layout in a cooling water pipe layout in the dissolving apparatus of the present invention.

FIG. 4 illustrates an example of structure of the dissolving tub, a U-shaped pipe and a vapor outlet pipe incorporated in the present invention.

FIG. 5 illustrates a top view of the dissolving apparatus of the present invention.

FIG. 6 illustrates connection between an apparatus for supplying hot water and a dissolving apparatus of the present invention.

FIG. 7 illustrates an example of filth treatment container of a portable toilet to which the filth treatment bag formed by hot water soluble film of polyvinyl alcohol is installed.

FIG. 8 illustrates relationship between a wastewater level in the dissolving tub and the temperature of the wastewater in the dissolving tub in terms of a process time.

FIG. 9 illustrates the order of a series of operations of the control of input/output of hot water, cooling water, cleaning water and wastewater.

### DETAILED DESCRIPTION OF THE PRESENT INVENTION

A vinyl film, the basic ingredient of which is polyvinyl alcohol, is used for the material of a filth treatment bag, which is dissolved by hot water. The vinyl film has a characteristic of being solved by hot water but not being dissolved by water having normal temperature. Since this vinyl film has a biodegradable characteristic, based on which the vinyl film is broken down into water and carbon dioxide by bacteria, this vinyl film has an advantage that the vinyl film does not give load onto a filth treatment facilities or environments after the dissolution of the vinyl bag.

A basic structure of an apparatus of the present invention for dissolving a filth treatment bag formed by a hot water soluble film of polyvinyl alcohol (PVA) and draining the dissolved bag together with filth to a sewer pipe will be described below.

A lid for closing the opening of a dissolving tub is provided on the upper portion of a dissolving tub. A U-shaped pipe for ejecting wastewater by utilizing siphon action is provided on the dissolving tub. An underwater heater is set on the bottom of the dissolving tub. A pipe for inputting hot water into the dissolving tub, a pipe for inputting cooling water into the dissolving tub, a pipe for inputting cleaning water into the dissolving tub and a pipe for ejecting vapor including odor from the dissolving tub are arranged on the upper portion of the dissolving tub.

By the arrangement of the present invention, the problems associated with the conventional technologies are solved as described below. Based on this structure described above, the filth treatment bag formed by a hot water soluble film of polyvinyl alcohol (PVA) storing filth is put into the dissolving apparatus of the present invention. The underwater heater set on the bottom of the dissolving tub heats the filth treatment bag formed by a hot water soluble film of polyvinyl alcohol (PVA).

The polyvinyl alcohol (PVA) film is completely dissolved by stirring action of the hot water stream from the pipe for inputting the hot water. Then, cooling water is inputted into the dissolving tub to drain wastewater, which is a mixture of the filth, the dissolved filth treatment bag and the hot water, to a sewer pipe by utilizing the siphon action of the U-shaped pipe. Lastly, the cleaning water is inputted through the pipe for cleaning water.

There are two reasons why inputting the hot water into the dissolving tub after throwing the filth treatment bag formed by polyvinyl alcohol film into the dissolving tub, even though the underwater heater is arranged on the bottom of the dissolving tub. First reason is that only the hot water, which is inputted into the dissolving tub, is not enough to keep the temperature to dissolve the filth treatment bag formed by polyvinyl alcohol film, since the filth coming out from the filth treatment bag formed by polyvinyl alcohol film lowers the temperature of the wastewater. The second reason is that the hot water supplied to the dissolving tub makes the time period necessary to boil the wastewater by the underwater heater shorter.

With regard to the material of the filth treatment bag formed by a hot water soluble film, the film having thickness of from 30 μm to 50 μm is used, the principal ingredient of which is, for example, polyvinyl alcohol.

A dissolving apparatus of the present invention is integrally equipped with a storage tank for storing cooling water. An underwater heater is arranged on the bottom of the dissolving tub. A U-shaped pipe is connected to the bottom of the dissolving tub. Further, an inlet of the hot water from an external hot water supply apparatus, an inlet of the cooling water from the storage tank for storing cooling water, an inlet of cleaning water for cleaning the internal structures of the dissolving tank, and an outlet of vapor for outputting vapor including odor in the dissolving tub, in which wastewater is boiled are provided in the side wall of the upper portion of the dissolving tub.

An electro-magnetic valve controls the open/close operation for inputting the hot water and the cleaning water. A sensor detects the quantity of the hot water and the cleaning water, which are inputted to the dissolving tub described above. A temperature sensor detects the temperature of wastewater including the filth, the dissolved filth bag and hot water in the dissolving tub. The underwater heater is turned off after a predetermined time period. The open/close operation of the electro-magnetic valve controls the input of cooling water.

A sequencer provided in the dissolving apparatus controls the open/close operation of all the electro-magnetic valves and the stop operation of the underwater heater.

Based on this structure, the hot water inputted into the dissolving tub and the heat generated by the underwater heater dissolve the filth treatment bag formed by the hot water soluble film of polyvinyl alcohol storing the filth inputted into an apparatus of the present invention. The filth flowing out from the filth treatment bag is mixed together with the hot water and sterilized by the hot water which is boiled by the underwater heater. At this moment, the vapor including odor generated in the dissolving tub is outputted from the outlet of vapor provided in the upper portion of the dissolving tub to a sewer system.

After boiling the wastewater for a predetermined time period, the underwater heater provided on the bottom of the dissolving tub is turned off. The water to be used for lowering the temperature of the wastewater is inputted into the dissolving tub. Then, the wastewater is outputted to the sewer pipe by the siphon action of the U-shaped pipe.

After the wastewater is outputted from the dissolving tub, inputted cleaning water from a spray type cleaning nozzle provided on the cleaning water inlet pipe flushes out residual subject left on the surface of the dissolving tub. After the cleaning water reaches to the level where the underwater heater is submerged, a series of process for the filth treatment finishes.

An example of the present invention will be described by referring to drawings below.

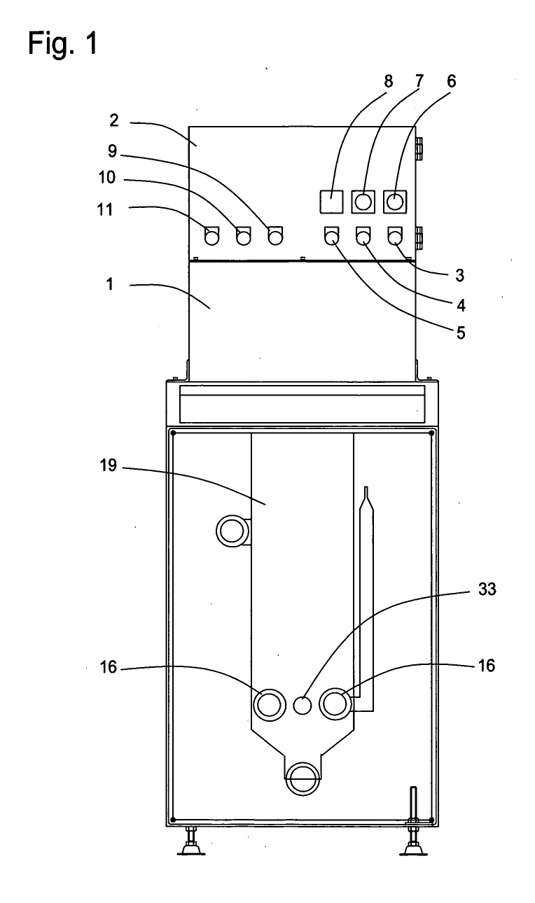

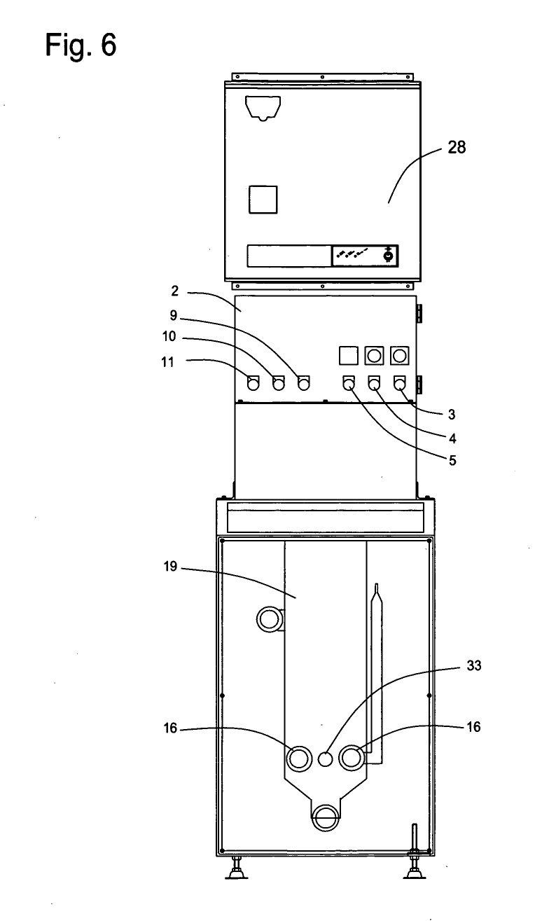

FIG. 1 illustrates a front view of the dissolving apparatus of the present invention for dissolving the filth treatment bag formed by a hot water soluble film. A cooling water storage tank 1 is integrally provided on the upper portion of the dissolving apparatus as shown in FIG. 1. A switchboard 2 is provided above the cooling water storage tank 1. The external apparatus 28 (FIG. 6) for supplying the hot water 28 is provided on a higher position than that of the dissolving tub 19.

Provided on the switch board 2 are a power switch 3, a power indicator lamp 5, a cooling water inputting timer 6, a water temperature indicator 7 for indicating temperature of the water in the dissolving tub 19, a heating time setting timer 8, a manual open/close switch 9 for manually opening or closing a hot water inputting valve, a manual open/close switch 10 for manually opening or closing a cooling water inputting valve, and a manual open/close switch 11 for manually opening or closing a cleaning water inputting valve.

It is preferable that, the manual open/close switch 9 for manually opening or closing the hot water inputting valve, the manual open/close switch 10 for manually opening or closing the cooling water inputting valve and the manual open/close switch 11 for manually opening or closing the cleaning water inputting valve are normally locked so that those keys cannot be operated other than a special situation such as maintenance service.

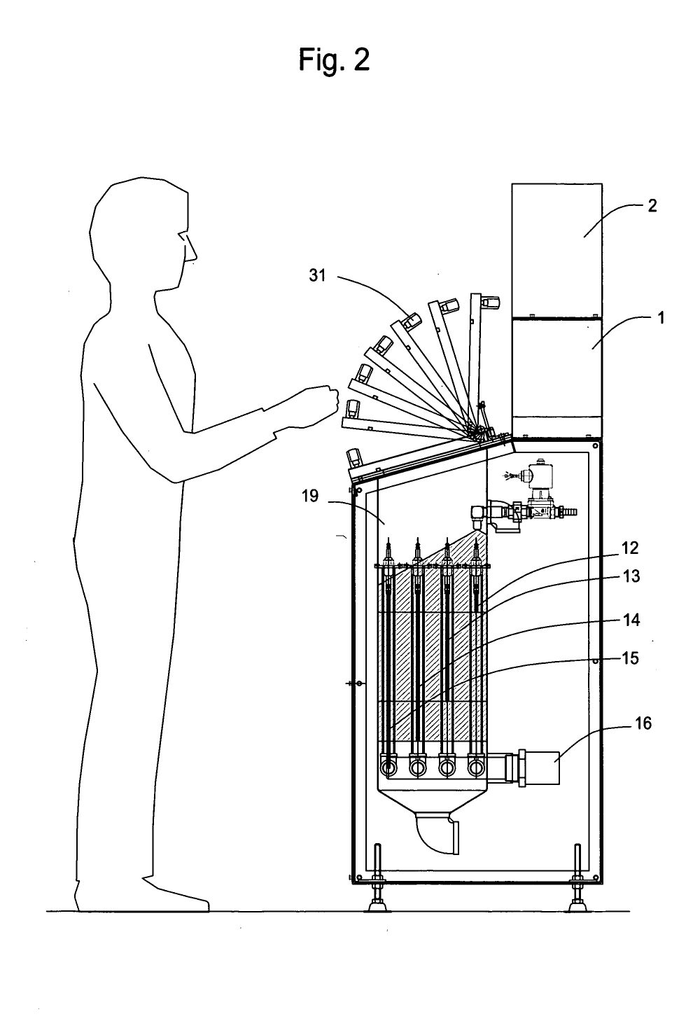

A water-temperature sensor 33, a sensor for detecting inputted cooling water quantity 12, a sensor for detecting inputted hot water quantity 13, a sensor for detecting inputted cleaning water quantity 14 and an electrode for sensors 15 are arranged on the side surface of the dissolving tub 19 as shown in FIG. 2. An underwater heater 16 is provided on the bottom of the dissolving tub 19. In this example, two underwater heaters are provided on the bottom of the dissolving tub 19.

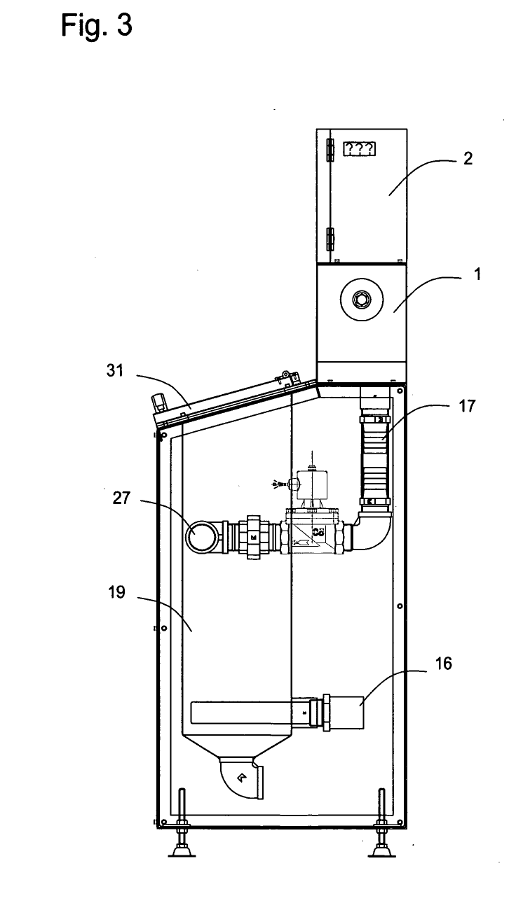

As illustrated in FIG. 3, a cooling water input pipe 17 is laid out from the cooling water storage tank 1 to the dissolving tub 19. An electro-magnetic valve 18 for inputting the cooling water controls the operation of introducing the cooling water into the dissolving tub 19 through a cooling water inlet 27.

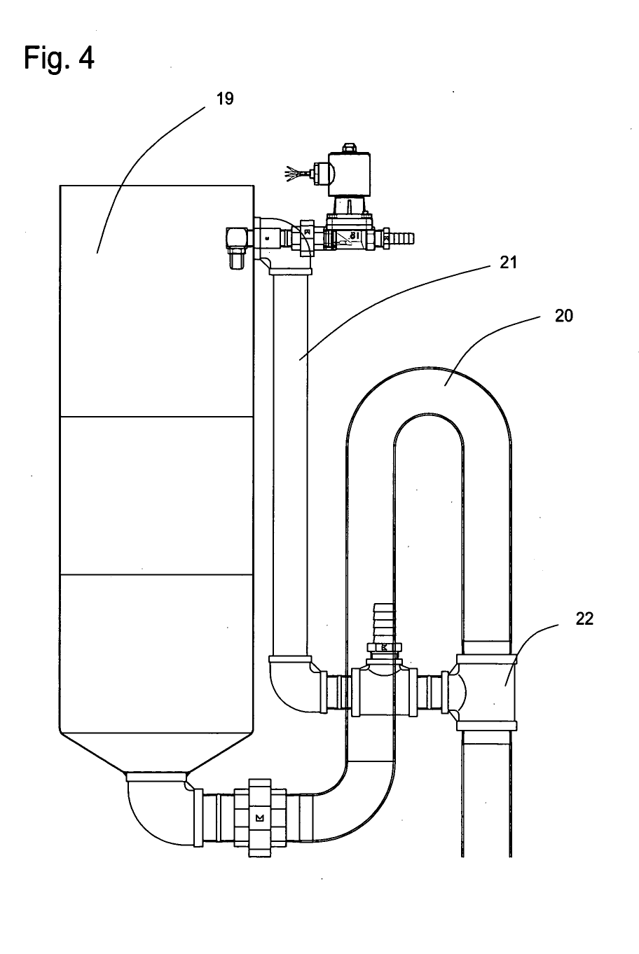

FIG. 4 illustrates a layout of the dissolving tub 19, a U-shaped pipe 20 and a vapor-outputting pipe 21 in the dissolving apparatus of the present invention. The vapor-outputting pipe 21 is connected to the U-shaped pipe 20 by a joint 22. The dissolving apparatus is arranged so that the odor and vapor in the dissolving tub 19 are outputted to a sewer pipe by using this pipe structure.

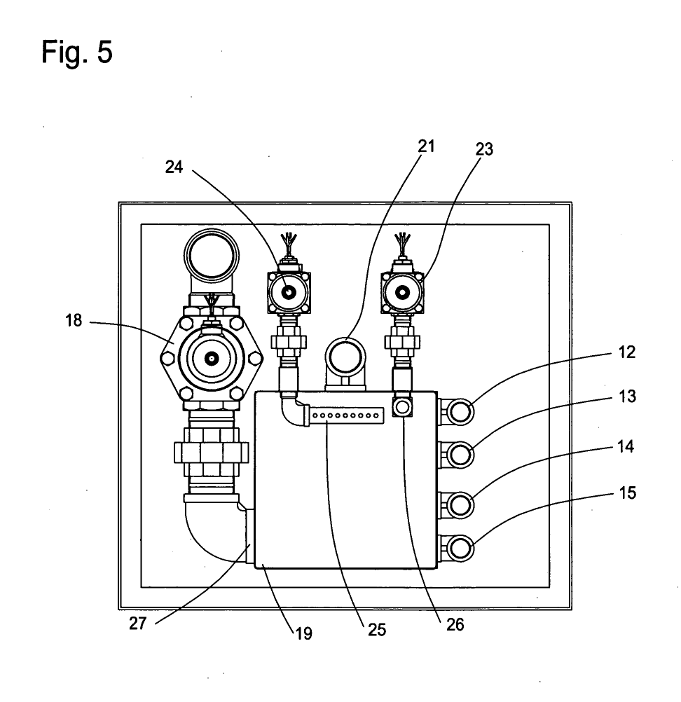

FIG. 5 illustrates a top view of the pipe layout viewing from the cooling water storing tank 1.

FIG. 6 illustrates a perspective view of the dissolving apparatus of the present invention equipped with an apparatus for supplying hot water 28. It is not necessary to provide the apparatus for supplying hot water 28 when setting up the dissolving apparatus at the place where other apparatus for supplying hot water is available, since the other apparatus for supplying hot water can be utilized instead of the apparatus for supplying hot water 28.

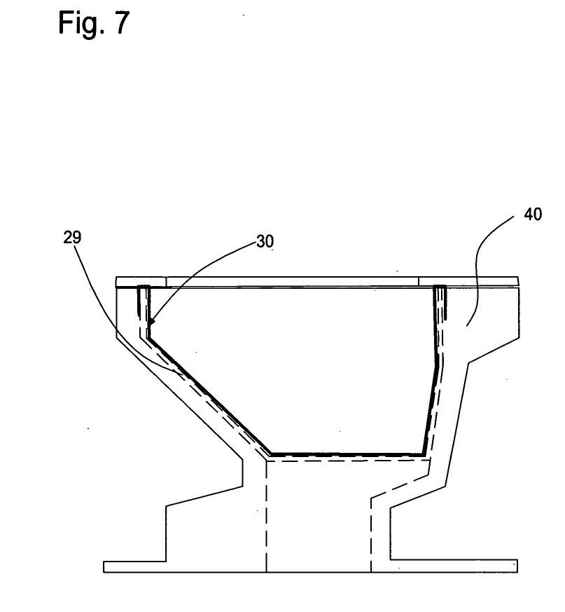

The filth treatment bag 30 formed by polyvinyl alcohol film storing the filth set in a filth storing tub 29 as shown in FIG. 7 is taken out from the filth storing tub 29 and put into the dissolving apparatus of the present invention. Then the lid 31 is closed and the start switch 4 is pushed. The dissolving apparatus starts operations, which will be described below.

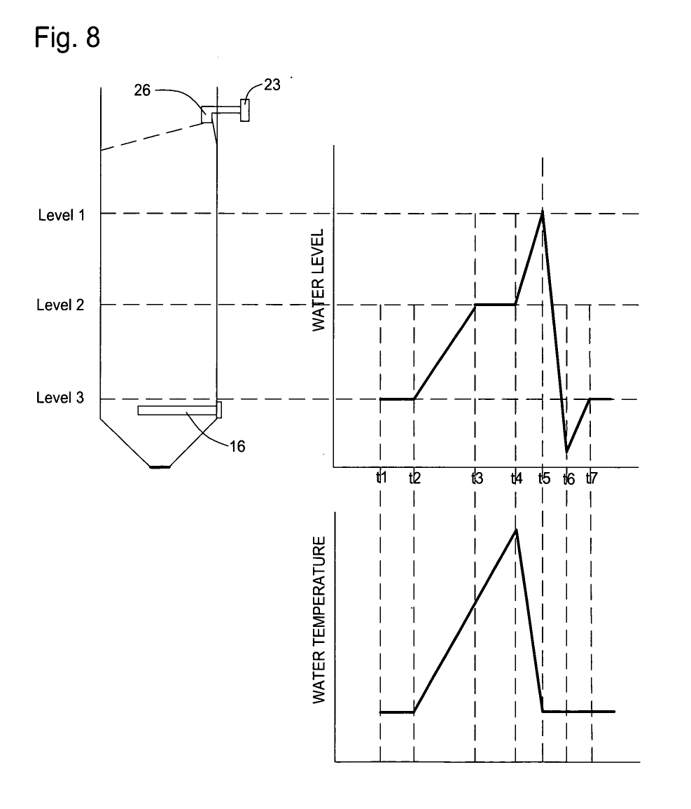

FIG. 8 illustrates the relationship between wastewater level and its temperature and a treatment time. The filth treatment bag 30 is put into the dissolving apparatus and when the start switch 4 is pushed, the dissolving apparatus starts operation at time t1 according to the following order described below.

Firstly, the hot water electro-magnetic valve 24 is opened to input the hot water from the apparatus for sullying hot water 28 into the dissolving tub 19 through the hot water supplying nozzle 25. At the same time, the underwater heater 16 is turned on at time t2. At this moment, the quantity of hot water from the apparatus for supplying hot water 28 is detected by the sensor for detecting input hot water quantity 13. When the inputted hot water reaches to a predetermined quantity (Level 2), the hot water electro-magnetic valve 24 is closed to stop supplying the hot water at time t3.

The water temperature detecting sensor 33 detects the temperature of wastewater in the dissolving tub 19 which is heated by the underwater heater 16. The underwater heater 16 is turned off when the time period set by the heating time setting timer 8 has passed. When the underwater heater 16 is turned off, the cooling water from cooling water input electro-magnetic valve 23 is arranged to input the cooling water at a stretch from the cooling water storage tank 1 through the cooling water inputting inlet 27 into the dissolving tub 19 at time t4.

Preferably, the quantity of cooling water inputted into the dissolving tub 19 is arranged to be the same as the quantity of the cooling water stored in the cooling water storing tank 1 in this embodiment. The cooling water inputted at the a stretch into the dissolving tank 19 from the cooling water storing tank 1 rapidly not only lowers the temperature of the wastewater but also rapidly raise the water level of the wastewater. As a result, a siphon action is caused in the U-shaped pipe 20 and the wastewater in the dissolving tub 19 is outputted to the sewer pipes (not shown) at time t5.

When the cooling water input electro-magnet valve 18 is closed and the time duration set by the cooling water input timer 6 has passed, the cleaning water input electro-magnetic valve 23 is opened to input the cooling water from a spray-type cleaning nozzle 26 at time t6. When the sensor for detecting cleaning water quantity 14 detects the quantity of cleaning water, which can sink the underwater heaters 16 under the water surface level, the cleaning water input electro-magnetic valve 23 is closed. Then the operation indicating lamp 4 is turned off and the dissolving apparatus returns to a standby mode at time t7.

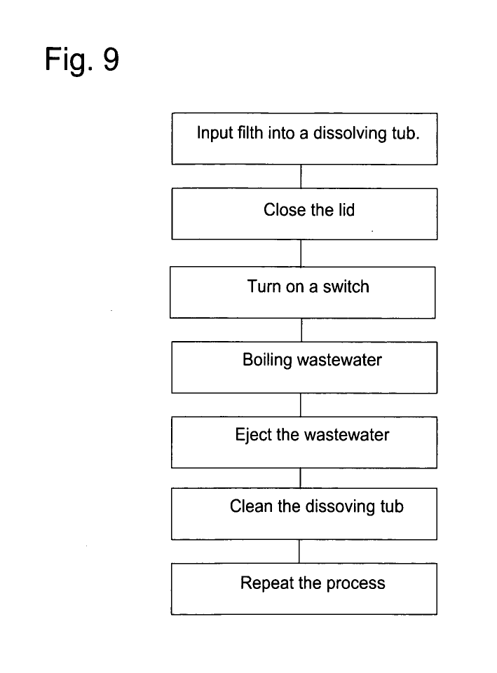

FIG. 9 illustrates the order of the process including a series of operations of the control of input/output of hot water, cooling water, cleaning water and wastewater into or from the dissolving tub 1 as described above. The order of process is represented from the top to the bottom.

The first step of the present invention is to take out the filth treatment bags formed by hot water soluble films storing the filth and/or urine from the filth storing tub of a portable toilet. The next step is to place the filth treatment bags storing the filth and/or urine into an apparatus of the present invention. The next step is to break down and dissolve the filth treatment bags by applying hot water to completely dissolve the filth treatment bag, which is mixed with wastewater by boiling them. The next step is to lower the temperature by inputting cooling water and to drain them out of the dissolving tub to sewer pipes.

Namely, it becomes possible for nursing stuffs to only take out the filth treatment bags formed by hot water soluble film storing filth from a portable toilet, to move it to the filth treatment room where the dissolving apparatus of the present invention is set after setting a new filth bag into the portable toilet and to place the filth treatment bags in the dissolving apparatus to complete a series of works in the filth treatment of a portable toilet.

According to the present invention, it becomes unnecessary to clean a filth container. Further, it also releases a nurse from the problems of odor and unsanitary associated with the treatment of a vinyl bag. Thus, the time spent for the treatment can be saved, which creates an extra time to be utilized for nursing and caring patients.

Further, the dissolving apparatus of the present invention completely breaks down and dissolves toilet paper in the dissolving tub of the toilet by applying a boiled hot water stream to drain them out to sewers. Thus, even though a large quantity of toilet paper is used, the sewers are not clogged. When the dissolving density of polyvinyl alcohol film is not more than 10%, the viscosity of solution is low enough to flush the solution to sewers. Accordingly, it becomes possible to treat a large quantity of filth and filth treatment bags at the same time.

In a hospital or a nursing facility, the number of times of disposal of filth and the cleaning work of the filth container reaches to several tens or hundreds in a day. Accordingly, the reduction effects of the working-hour and its service-hour of the nursing stuffs generate a large cost reduction.

According to the present invention, since the boiled hot water stream stirs wastewater for a predetermined time period, the bacterial of the wastewater are killed. Thus, there is a useful effect on the suppression of the infection within a hospital and the filth treatment of infected patients.

Although the invention is described herein with reference to the preferred embodiment, one skilled in the art will readily appreciate that various modifications and variations may be made without departing from the spirit and scope of the present invention. Such modifications and variations are considered to be within the purview and scope of the appended claims and their equivalents.

What is claimed is:

1. An apparatus for dissolving a filth treatment bag formed by a hot water soluble film, comprising:
a dissolving tub;
a pipe for inputting hot water in the dissolving tub for dissolving the filth bag storing filth by stirring action of the hot water therefrom;
a pipe for outputting vapor including odor generated by a mixture of the filth and the hot water in the dissolving tub, the vapor being generated on a shifting process from a state where the film is divided and collapsed to a stage where the film is dissolved; and
a mechanism for cooling heated wastewater including the dissolved filth bag and the hot water in the dissolving tub and outputting the wastewater into a sewer pipe from the dissolving tub.

2. An apparatus for dissolving a filth treatment bag of claim 1, further comprising:
a lid for covering an opening provided on the dissolving tub, the opening being used for inputting the filth treatment bag into the dissolving tub;
a hot water inlet for inputting the hot water into the dissolving tub, the hot water inlet being provided on a sidewall of an upper portion of the dissolving tub;
a cooling water inlet for inputting cooling water into the dissolving tub to output wastewater in the dissolving tub by applying a siphon phenomenon;
a cleaning water inlet for inputting cleaning water into the dissolving tub after outputting the wastewater from the dissolving tub;
a vapor outlet for outputting the vapor; and
an underwater heater for raising temperature of the wastewater.

3. An apparatus for dissolving a filth treatment bag of claim 1, further comprising:
a tank for storing the cooling water; and
an apparatus for supplying the hot water.

4. An apparatus for dissolving a filth treatment bag of claim 2, further comprising:
a tank for storing the cooling water; and
an apparatus for supplying the hot water.

5. An apparatus for dissolving a filth treatment bag of claim 2,
wherein a series of works of inputting hot water into the dissolving tub, heating the hot water in the dissolving tub, stopping heating operation of the hot water, inputting water into the dissolving tub for cooling, outputting the hot water from the dissolving tub and cleaning an inside of the dissolving tub is automatically performed after inputting the filth treatment bag formed by hot water soluble film storing filth in the dissolving tub.

6. An apparatus for dissolving a filth treatment bag of claim 3,
wherein a series of works of inputting hot water into the dissolving tub, heating the hot water in the dissolving tub, stopping heating operation of the hot water, inputting water into the dissolving tub for cooling, outputting the hot water from the dissolving tub and cleaning an inside of the dissolving tub is automatically performed after inputting the filth treatment bag formed by hot water soluble film storing filth in the dissolving tub.

7. An apparatus for dissolving a filth treatment bag of claim 4,
wherein a series of works of inputting hot water into the dissolving tub, heating the hot water in the dissolving tub, stopping heating operation of the hot water, inputting water into the dissolving tub for cooling, outputting the hot water from the dissolving tub and cleaning an inside of the dissolving tub is automatically performed after inputting the filth treatment bag formed by hot water soluble film storing filth in the dissolving tub.

8. An apparatus for dissolving a filth treatment bag of claim 1, further comprising:
a sensor for detecting a quantity of the hot water;
a sensor for detecting a quantity of the water into the dissolving tub for cooling and outputting hot water from the dissolving tub; and a sensor for detecting a quantity of cleaning water;
a computer for controlling an operation of the apparatus for dissolving a filth treatment;
wherein the computer controls a series of works of inputting hot water into the dissolving tub, heating the hot water in the dissolving tub, stopping heating operation of the hot water, inputting water into the dissolving tub for cooling, outputting the hot water from the dissolving tub and cleaning an inside of the dissolving tub by using the sensor for detecting a quantity of the hot water, the sensor for detecting a quantity of the water into the dissolving tub for cooling and outputting hot water from the dissolving tub, and the sensor for detecting a quantity of cleaning water after inputting the filth treatment bag formed by hot water soluble film storing filth in the dissolving tub.

9. An apparatus for dissolving a filth treatment bag of claim 2, further comprising:
a sensor for detecting a quantity of the hot water;
a sensor for detecting a quantity of the water into the dissolving tub for cooling and outputting hot water from the dissolving tub; and a sensor for detecting a quantity of cleaning water;
a computer for controlling an operation of the apparatus for dissolving a filth treatment;
wherein the computer controls a series of works of inputting hot water into the dissolving tub, heating the hot water in the dissolving tub, stopping heating operation of the hot water, inputting water into the dissolving tub for cooling, outputting the hot water from the dissolving tub and cleaning an inside of the dissolving tub by using the sensor for detecting a quantity of the hot water, the sensor for detecting a quantity of the water into the dissolving tub for cooling and outputting hot water from the dissolving tub, and the sensor for detecting a quantity of cleaning water after inputting the filth treatment bag formed by hot water soluble film storing filth in the dissolving tub.

10. An apparatus for dissolving a filth treatment bag of claim 3, further comprising:
a sensor for detecting a quantity of the hot water;
a sensor for detecting a quantity of the water into the dissolving tub for cooling and outputting hot water from the dissolving tub; and
a sensor for detecting a quantity of cleaning water;
a computer for controlling an operation of the apparatus for dissolving a filth treatment;
wherein the computer controls a series of works of inputting hot water into the dissolving tub, heating the hot water in the dissolving tub, stopping heating operation of the hot water, inputting water into the dissolving tub for cooling, outputting the hot water from the dissolving tub and cleaning an inside of the dissolving tub by using the sensor for detecting a quantity of the hot water, the sensor for detecting a quantity of the water into the dissolving tub for cooling and outputting hot water from the dissolving tub, and the sensor for detecting a quantity of cleaning water after inputting the filth treatment bag formed by hot water soluble film storing filth in the dissolving tub.

11. An apparatus for dissolving a filth treatment bag of claim 4, further comprising:
a sensor for detecting a quantity of the hot water;
a sensor for detecting a quantity of the water into the dissolving tub for cooling and outputting hot water from the dissolving tub; and a sensor for detecting a quantity of cleaning water;
a computer for controlling an operation of the apparatus for dissolving a filth treatment;
wherein the computer controls a series of works of inputting hot water into the dissolving tub, heating the hot water in the dissolving tub, stopping heating operation of the hot water, inputting water into the dissolving tub for cooling, outputting the hot water from the dissolving tub and cleaning an inside of the dissolving tub by using the sensor for detecting a quantity of the hot water, the sensor for detecting a quantity of the water into the dissolving tub for cooling and outputting hot water from the dissolving tub, and the sensor for detecting a quantity of cleaning water after inputting the filth treatment bag formed by hot water soluble film storing filth in the dissolving tub.

12. An apparatus for dissolving a filth treatment bag of claim 5, further comprising:
a sensor for detecting a quantity of the hot water;
a sensor for detecting a quantity of the water into the dissolving tub for cooling and outputting hot water from the dissolving tub; and a sensor for detecting a quantity of cleaning water;
a computer for controlling an operation of the apparatus for dissolving a filth treatment;
wherein the computer controls a series of works of inputting hot water into the dissolving tub, heating the hot water in the dissolving tub, stopping heating operation of the hot water, inputting water into the dissolving tub for cooling, outputting the hot water from the dissolving tub and cleaning an inside of the dissolving tub by using the sensor for detecting a quantity of the hot water, the sensor for detecting a quantity of the water into the dissolving tub for cooling and outputting hot water from the dissolving tub, and the sensor for detecting a quantity of cleaning water after inputting the filth treatment bag formed by hot water soluble film storing filth in the dissolving tub.

13. An apparatus for dissolving a filth treatment bag of claim 6, further comprising:
a sensor for detecting a quantity of the hot water;
a sensor for detecting a quantity of the water into the dissolving tub for cooling and outputting hot water from the dissolving tub; and a sensor for detecting a quantity of cleaning water;
a computer for controlling an operation of the apparatus for dissolving a filth treatment;
wherein the computer controls a series of works of inputting hot water into the dissolving tub, heating the hot water in the dissolving tub, stopping heating operation of the hot water, inputting water into the dissolving tub for cooling, outputting the hot water from the dissolving tub and cleaning an inside of the dissolving tub by using the sensor for detecting a quantity of the hot water, the sensor for detecting a quantity of the water into the dissolving tub for cooling and outputting hot water from the dissolving tub, and the sensor for detecting a quantity of cleaning water after inputting the filth treatment bag formed by hot water soluble film storing filth in the dissolving tub.

14. An apparatus for dissolving a filth treatment bag of claim 7, further comprising:
a sensor for detecting a quantity of the hot water;
a sensor for detecting a quantity of the water into the dissolving tub for cooling and outputting hot water from the dissolving tub; and a sensor for detecting a quantity of cleaning water;
a computer for controlling an operation of the apparatus for dissolving a filth treatment;
wherein the computer controls a series of works of inputting hot water into the dissolving tub, heating the hot water in the dissolving tub, stopping heating operation of the hot water, inputting water into the dissolving tub for cooling, outputting the hot water from the dissolving tub and cleaning an inside of the dissolving tub by using the sensor for detecting a quantity of the hot water, the sensor for detecting a quantity of the water into the dissolving tub for cooling and outputting hot water from the dissolving tub, and the sensor for detecting a quantity of cleaning water after inputting the filth treatment bag formed by hot water soluble film storing filth in the dissolving tub.

15. An apparatus for dissolving a filth treatment bag of claim 3,
wherein the apparatus for supplying the hot water is provided on a position, which is a higher position than a position of the dissolving tub.

16. An apparatus for dissolving a filth treatment bag of claim 4,
wherein the apparatus for supplying the hot water is provided on a position, which is a higher position than a position of the dissolving tub.

17. An apparatus for dissolving a filth treatment bag of claim 5,
wherein the apparatus for supplying the hot water is provided on a position, which is a higher position than a position of the dissolving tub.

18. An apparatus for dissolving a filth treatment bag of claim 2, further comprising:
a hot water inputting valve for controlling of input of the hot water;
a cooling water inputting valve for controlling input of the cooling water; and
a cleaning water inputting valve for controlling input of the cleaning water.

19. An apparatus for dissolving a filth treatment bag of claim 18, further comprising:
a manual open/close switch for manually opening or closing the hot water inputting valve;
a manual open/close switch for manually opening or closing the cooling water inputting valve; and
a manual open/close switch for manually opening or closing the cleaning water inputting valve.

20. An apparatus for dissolving a filth treatment bag of claim 19,
wherein the manual open/close switch for manually opening or closing the hot water inputting valve, the manual open/close switch for manually opening or closing the cooling water inputting valve and the manual open/close switch for manually opening or closing the cleaning water are arranged to be locked.
